(19) United States
(12) Patent Application Publication
(10) Pub. No.: US 2019/0039249 A1
(43) Pub. Date: Feb. 7, 2019

(54) MULTI-AXIS ROBOT AND METHOD FOR CONTROLLING THE SAME FOR PAINTING OBJECTS

(71) Applicant: EISENMANN SE, Böblingen (DE)

(72) Inventors: Stephan Schwab, Waldenbuch (DE); Mirjam Salomon, Wildberg (DE)

(21) Appl. No.: 16/074,610

(22) PCT Filed: Jan. 24, 2017
(86) PCT No.: PCT/EP2017/051445

§ 371 Date: Aug. 1, 2018

(30) Foreign Application Priority Data
Feb. 2, 2016 (DE) 10 2016 001 073.8

(51) Int. Cl. B25J 11/00; B25J 9/16; B25J 9/00

(52) U.S. Cl. CPC B25J 11/0075; B25J 9/1679; B05B 13/0292; B25J 9/1664; B25J 9/003

(57) ABSTRACT

A multi-axis robot having a kinematic chain with a tool member and at least one additional member, the tool member supporting a first tool. The associated robot control mechanism comprises a kinematic control mechanism designed to receive the movement path of the first tool using a parameterizable tool center point and to control members of the kinetic chain in such a way that the tool center point follows the movement path. The robot control mechanism maintains all the members along the kinematic chain of the tool member of another member which supports the second tool in a fixed position, it parameterizes the tool center point on a working point of the second tool, and transfers the movement path of the second tool to the kinematic control mechanism so that the latter, under the condition that the fixed position of the members is maintained, controls the remaining members of the kinematic chain using the newly parameterized tool center point so that the tool center point follows the movement path of the second tool.

### BACKGROUND OF THE INVENTION

### 1. Field of the Invention

The invention relates to a multi-axis robot, in particular a painting robot,
a) having a kinematic chain which has a tool member and at least one further member,
b) the tool member carrying a first tool, in particular an application unit,
c) having a robot controller which, in order to control the first tool, comprises a kinematic controller which is set up to accept the movement path of the first tool using a parameterizable tool center point and thereupon to actuate the members of the kinematic chain in such a way that the tool center point follows the movement path.

Furthermore, the invention relates to an associated paint shop, and to methods for controlling a multi-axis robot, for programming a multi-axis robot, and for painting objects.

### 2. Description of the Prior Art

It is currently common practice that multi-axis robots are shipped with a kinematic controller which is adapted to the kinematic chain thereof, that is to say to the number and configuration of the movable members and movement axes of the multi-axis robot. The kinematic controller contains a complete kinematic model of the kinematic chain of the multi-axis robot, which complete kinematic model allows the movement path of a tool which is attached at the front end of the multi-axis robot to be programmed in a simple way. Here, depending on the attached tool on the terminal tool member, what is known as a tool center point is stored as reference point for the tool position in the kinematic controller, which tool center point is then to move along the movement path which is necessary for the process sequence via corresponding programming.

In this context, it goes without saying that the orientation of the tool with regard to the tool center point and the movement speed along the movement path are also taken into consideration, with the result that the tool center point is usually a vectorial value. For the sake of simplicity, however, statements in this regard will not be made further in the following text, since a person skilled in the art knows this procedure.

Thereupon, with consideration of the complete kinematic chain of the multi-axis robot, the kinematic controller of the robot manufacturer takes over the calculation of the positions of the different members of the multi-axis robot, which positions are necessary for the movement, and actuates the actuators correspondingly. Here, the kinematic controller ensures, for example, that the respective members are actuated only within predefined movement ranges for collision avoidance, that the new position along the movement path is reached as rapidly as possible, or that movements which are as energy-efficient as possible take place to this end.

Therefore, the operator can program the multi-axis robot in a simple way with the aid of the kinematic controller such that it accomplishes the tasks which are provided for it.

However, experience has shown, for example in the case of painting of objects such as vehicle bodies, that a second tool is required in some situations, which second tool is not fastened to the tool member, but rather to a member which is arranged further to the rear in the kinematic chain. This is to do with the fact that the front members of a multi-axis robot are more slender and can apply correspondingly less force.

In this case, in accordance with the previously known procedure, the operator of the multi-axis robot would have to bypass the kinematic controller of the robot manufacturer as far as possible, and would have to calculate and actuate the required positions of the members himself/herself. This is merely unsatisfactorily successful within the context of the cost and effort specifications of a project.

### SUMMARY OF THE INVENTION

It is therefore an object of the present invention to specify a multi-axis robot and methods for controlling it, which permit the use of a second tool.

According to the invention, this is achieved by virtue of the fact that
d) the at least one further member carries a second tool, and that
e) the robot controller is set up to control the second tool in such a way that it
   fixes all the members along the kinematic chain from the tool member to the at least one further member which carries the second tool in a fixing position,
   parameterizes the tool center point to a working point of the second tool, and
   transfers the movement path of the second tool to the kinematic controller, with the result that said kinematic controller, under the secondary condition that the fixing position of the members is maintained, actuates the members of the kinematic chain using the newly parameterized tool center point in such a way that the tool center point follows the movement path of the second tool.

The inventors have recognized that a kinematic controller can also be used to control a second tool which is carried by a different member than the tool member if the degrees of freedom of the kinematic chain between the terminal tool member and the other member are blocked, by the member or members which lies/lie in between being fixed. Typical kinematic controllers permit fixing of this type of individual members or a plurality of members, for example for collision avoidance.

Thereupon, the geometry between the tool member and the working point of the second tool is defined precisely by way of the fixing of the members, with the result that basically a type of virtual tool is produced for the kinematic controller by way of parameterizing of the tool center point which is stored in the kinematic controller to the working point of the second tool, which virtual tool comprises all members as far as the second tool, starting from the tool member. The term “all members” also comprises only a single member which would then be the tool member.

As a result, the kinematic controller continues to control the tool center point with the aid of the intrinsic kinematic model in relation to the terminal tool member. Here, however, the secondary conditions with regard to the fixed members are complied with, with the result that ultimately only the rear member or the rear members up to and including that member which carries the second tool is/are moved.

First and second tools within the context of the present invention can be, for example, application units such as rotation atomizers, spray guns or print heads, grippers, door or hood openers, measuring units such as scanners or optical or mechanical surface measuring units, welding heads or tools for intermediate drying such as radiators or air nozzles.

In the case of the change to the second tool, the members which are fixed can be moved in a simple way into a previously defined fixing position. As a result, the position of the working point of the second tool with regard to the tool member is already known and can be parameterized correspondingly. The fixing position preferably corresponds, however, to a position which the member or members to be fixed adopts/adopt immediately before the change to the second tool. In this case, the robot controller has to be set up to calculate the position of the working point with regard to the tool member in each case during the change, in order to parameterize the kinematic controller correctly. In this way, unnecessary movements of the members are avoided.

During the parameterizing of the tool center point to the working point of the second tool, the outer contour of the fixed part of the kinematic chain is preferably also parameterized. As a result, the collision monitoring of the kinematic controller can continue to be used.

If the kinematic controller already permits the calculation under the secondary condition of fixed members, the moment of inertia of the members should already be taken into consideration in said calculation. An adaptation of the moment of inertia of the tools to the changed tool center point would possibly also have to be performed, however (that is to say, basically a transfer into the changed tool center point coordinate system).

Furthermore, the at least one further member can carry a plurality of second tools. In this case, the robot controller can be set up to parameterize the tool center point in each case to that second tool which is to be controlled. In this way, a plurality of different tools, for example a door opener and a hood opener which is separate therefrom, can be provided and actuated on a rear member of the kinematic chain.

It goes without saying that the actuation principle according to the invention can also be applied to tools on different members. For instance, a plurality of second tools can also be arranged on different further members. To this end, the robot controller can be set up such that it fixes the corresponding members along the kinematic chain from the tool member as far as the respective further member which carries the respective second tool in a fixing position, and that it parameterizes and actuates the kinematic controller correspondingly.

With regard to a paint shop for painting objects, in particular vehicle bodies or vehicle fixtures, a multi-axis robot of this type can advantageously be used as a painting robot.

With regard to a method according to the invention for controlling a multi-axis robot, in particular a painting robot, with a kinematic chain which has a tool member and at least one further member, it being possible for the tool member to carry a first tool, in particular an application unit, and for the at least one further member to carry a second tool, the following steps are provided:
a) providing of a robot controller which, in order to control the first tool, comprises a kinematic controller which is set up to accept the movement path of the first tool using a parameterizable tool center point and thereupon to actuate the members of the kinematic chain in such a way that the tool center point follows the movement path;
b) fixing of all the members along the kinematic chain from the tool member to the at least one further member which carries the second tool in a fixing position;
c) parameterizing of the tool center point of the kinematic controller to a working point of the second tool;
d) transferring of the movement path of the second tool to the kinematic controller, with the result that said kinematic controller, under the secondary condition that the fixing position of the members is maintained, actuates the members of the kinematic chain using the newly parameterized tool center point in such a way that the tool center point follows the movement path of the second tool.

The following steps can preferably be carried out beforehand:
a) programming of the movement path of the first tool with the aid of a tool center point;
b) programming of the movement path of the second tool with the aid of a tool center point under the secondary condition that the fixing position of the members is maintained.

The method according to the invention can preferably also be used to control a multi-axis robot with a kinematic chain of x-n members with the aid of a kinematic controller which is designed for a multi-axis robot with x members. In this case, the real tool member of the multi-axis robot with x-n members corresponds to the second tool for the control purposes. Here, the terminal n members are fixed completely, with the result that the kinematic controller maintains them during the entire process as a fixed secondary condition.

The above-described teaching can particularly advantageously be used in a method for painting an object with a movable component, in particular a vehicle body with a door, an engine hood, a trunk lid and/or a fuel filler flap. To this end, it comprises the following steps:
a) providing of a painting robot, with a kinematic chain which has a tool member and at least one further member, the tool member carrying an application unit as a first tool, and the at least one further member carrying a second tool;
b) using of the method according to the invention to control the painting robot, in order to move the movable component with the second tool;
c) painting of the object before and/or after the movement of the movable component with the aid of the application unit.

Furthermore, a method for implementing a multi-axis robot, in particular a painting robot, with a kinematic chain which has a tool member and at least one further member, it being possible for the tool member to carry a first tool, in particular an application unit, and for the at least one further member to carry a second tool, can comprise the following steps:
a) programming of the movement path of the first tool, in particular of an application unit, into a kinematic controller which is set up to accept the movement path of the first tool using a parameterizable tool center point and thereupon to actuate the members of the kinematic chain in such a way that the tool center point follows the movement path;
b) fixing of all the members along the kinematic chain from the tool member to the at least one further member which carries the second tool in a fixing position;
c) parameterizing of the tool center point of the kinematic controller to a working point of the second tool;
d) programming of the movement path of the second tool into the kinematic controller, with the result that said kinematic controller, under the secondary condition that the fixing position of the members is maintained, can actuate the members of the kinematic chain using the newly parameterized tool center point in such a way that the tool center point follows the movement path of the second tool.

### BRIEF DESCRIPTION OF THE DRAWINGS

In the following text, exemplary embodiments of the invention will be described in greater detail using the drawings, in which:

FIG. 1 shows a perspective view of a paint shop with two multi-axis robots as painting robots;

FIG. 2 shows a diagrammatic partial view in cross section through the paint shop, which partial view illustrates the programming of a movement path of an application unit;

FIG. 3 shows a diagrammatic partial view in cross section through the paint shop, which partial view illustrates the programming of a movement path of another actuating element; and

FIG. 4 shows a flow chart which shows the method steps for the reduction of the kinematics.

### DESCRIPTION OF PREFERRED EXEMPLARY EMBODIMENTS

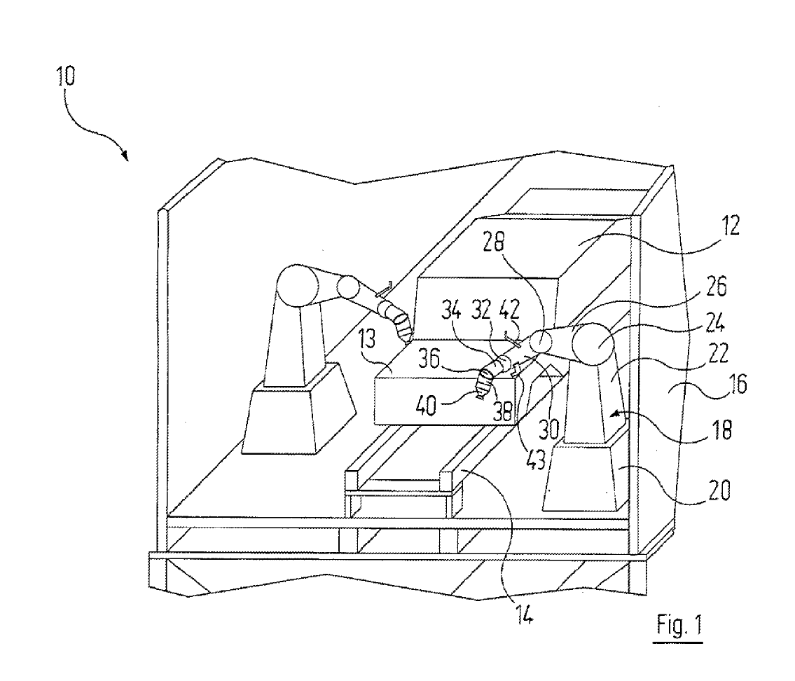

FIG. 1 shows a perspective view of a detail of an exemplary paint shop 10 which is provided here for painting vehicle bodies 12 or their fixtures which have, for example, an engine hood 13 as a movable component.

To this end, the vehicle bodies 12 are moved with the aid of a conveying device 14 through a paint booth 16, in which multi-axis robots are arranged as painting robots 18.

In the exemplary embodiment which is shown here, a painting robot 18 of this type first of all has a pedestal 20 and a trunk element 22. A triaxial joint 24 which establishes an articulated connection to a first arm section 26 is arranged on said trunk element 22 at the upper end. A uniaxial joint 28 which for its part establishes an articulated connection between the first arm section 26 and a second arm section 30 is arranged at the other end of the first arm section 26. A triaxial joint 32 which for its part carries a third arm section 34 is in turn arranged on the second arm section 30. Said third arm section 34 has a uniaxial joint 36 which carries a hand section 38, on which the first tool (in this case, a rotation atomizer 40 with a bell disk) is mounted.

Furthermore, the painting robot 18 has an actuating element as a second tool (here, an engine hood opener 42 by way of example) on the second arm section 30. Here, furthermore, a fuel filler flap opener 43 is provided on the same second arm section 30, moreover, as a second tool which can be used as an alternative.

The different joints and sections of the painting robot 18 from the pedestal 20 as far as the hand section 30 together form the kinematic chain of the painting robot 18.

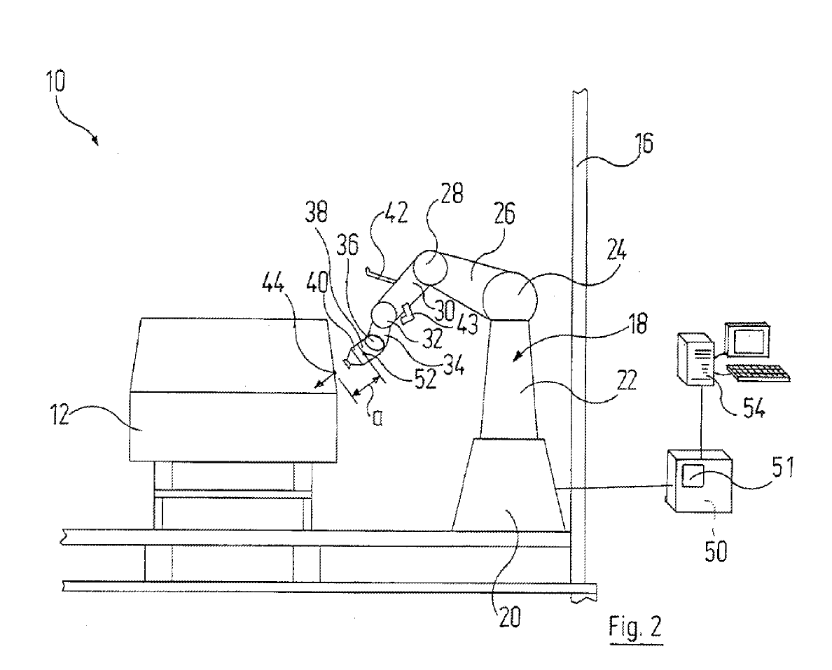

In order to fix how the rotation atomizer 40 moves around the vehicle body 12, the rotation atomizer 40 is assigned what is known as a tool center point 44 as a reference point, as can be seen from FIG. 2. Said tool center point 44 can be that point, at which the rotation atomizer 40 emits its optimum jet pattern. Said tool center point 44 is then guided as needed over the surface of a vehicle body 12 to be painted in each case during the implementation phase of the paint shop 10. Here, the tool center point 44 can also be guided in front of or behind the actual vehicle body surface, in order to produce a larger or smaller painting patch, for example.

In order to control the robot 18, said robot 18 is connected to a robot controller 50 which comprises a kinematic controller 51 which is typically included by the manufacturer of the corresponding multi-axis robot. The robot controller is connected to an operating computer 52 for programming purposes.

A tool zero point 54 is stored in the kinematic controller 51, with regard to which tool zero point 54 the tool center point 44 is fixed depending on the tool. In FIG. 2, this is indicated by way of the double arrow a which it goes without saying is to be considered vectorially. If the painting robot 18 is operated with another tool, for example as a result of an automated tool change during a painting process or between different painting processes, for example in the case of the change to other vehicle bodies 12, the tool center point 44 can thus be newly parameterized.

Via the operating computer 52, the movement path of the tool center point 44 or the rotation atomizer 40 including its orientation along the vehicle body 12 is then programmed in a simple way, for example in the form of a multiplicity of individual support points of a spline curve.

In order to open and to close the engine hood of the vehicle body 12, for example, during a painting process, the engine hood opener 42 is used. On account of the fact that the engine hood opener 42 is arranged on the second arm section 30 and the rear joints and members and the associated actuators of the painting robot 18 are by nature of larger dimensions than the front elements, the painting robot 18 is capable of this, since a sufficient force can then be applied by way of the engine hood opener 42.

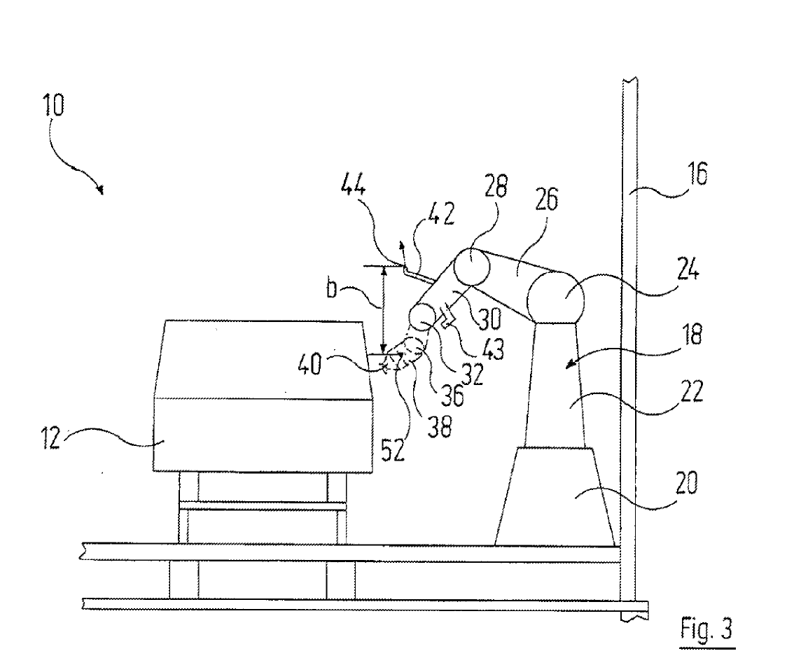

In order to also achieve a simple programmability with the aid of the kinematic controller 51 for the movement of the engine hood opener 42, the two last joints 32 and 36 are fixed either in their instantaneous position or in a position fixed in advance (as indicated in FIG. 3 by way of the dashing). In a manner which is dependent on the fixed position, the tool center point 44 is then parameterized with regard to the tool zero point 54 to the working point of the engine hood opener 42 (cf. double arrow b).

As in the case of the rotation atomizer 40 which is attached at the front of the painting robot 18, furthermore, the moment of inertia of the corresponding components, by which the kinematic chain of the painting robot 18 has been reduced by way of the fixing of the joints 32 and 36, is parameterized. Afterward, the engine hood opener 42 can be controlled in accordance with its required movement path via the customary kinematic controller 51 with the aid of a path planning operation. For this purpose, the operating computer 52 accesses the known kinematic controller 51 via the robot controller 50, the joints 32 and 36 remaining fixed as a secondary condition in the kinematic model.

In the same way as the control operation of the engine hood opener 42 takes place, the fuel filler flap opener 43 can also be operated. Here, the tool center point 44 is then defined in a correspondingly differing manner in the kinematic controller 51. If the fuel filler flap opener 43 were arranged on another member of the kinematic chain, correspondingly more or fewer joints would have to be fixed.

In the present exemplary embodiment, the invention has been described using a painting robot 18 with four joints, on which the robot kinematics have been reduced by the last two joints for the path planning operation. It goes without saying that it is clear to a person skilled in the art, however, that this principle can basically be extended as desired to the extent that more or fewer members are available as degrees of freedom and a reduction by more or fewer members takes place.

In this way, it is possible, even in the case of in future even more slender multi-axis robots with regard to different members of the kinematic chain, to perform the programming of the individual tools, by the known means of a path planning operation being relied upon.

What is claimed is:

1. A multi-axis robot comprising:
a) a kinematic chain which has a tool member and at least one further member,
b) the tool member carrying a first tool,
a robot controller which, in order to control the first tool, comprises a kinematic controller which is set up to accept a movement path of the first tool using a parameterizable tool center point and thereupon to actuate the at least one further member of the kinematic chain in such a way that the tool center point follows the movement path,
wherein
d) the at least one further member carries a second tool, and in that
e) the robot controller is set up to control the second tool in such a way that it
fixes any members along the kinematic chain from the tool member to the at least one further member which carries the second tool in a fixing position,
parameterizes the tool center point to a working point of the second tool, and
transfers a movement path of the second tool to the kinematic controller, with the result that said kinematic controller, under the secondary condition that the fixing position of the members is maintained, actuates any remaining members of the kinematic chain using the newly parameterized tool center point in such a way that the tool center point follows the movement path of the second tool.

2. The multi-axis robot as claimed in claim 1, wherein the fixing position corresponds to a position which the member or members to be fixed assume immediately before the change to the second tool.

3. The multi-axis robot as claimed in claim 1, wherein the outer contour of the fixed part of the kinematic chain is also parameterized during the parameterization of the tool center point to the working point of the second tool.

4. The multi-axis robot as claimed in claim 1, wherein the at least one further member carries a plurality of second tools, and in that the robot controller is set up to parameterize the tool center point in each case to that second tool which is to be controlled.

5. The multi-axis robot as claimed in claim 1, wherein a plurality of second tools are arranged on different further members and, in order to control the respective second tool, the robot controller is set up such that it fixes the corresponding members along the kinematic chain from the tool member to the respective further member which carries the respective second tool in a fixing position, and that it parameterizes and actuates the kinematic controller correspondingly.

6. A paint shop for painting objects comprising a multi-axis robot as claimed in claim 1.

7. A method for controlling a multi-axis robot comprising the following steps:
a) providing of a robot controller for controlling a multi-axis robot having a kinematic chain which has a tool member and at least one further member, it being possible for the tool member to carry a first tool and for the at least one further member to carry a second tool, the robot controller comprising a kinematic controller (51) which is set up to accept a movement path of the first tool using a parameterizable tool center point and thereupon to actuate the members of the kinematic chain in such a way that the tool center point follows the movement path;
b) fixing of all the members along the kinematic chain from the tool member to the at least one further member which carries the second tool in a fixing position;
c) parameterizing of the tool center point of the kinematic controller to a working point of the second tool;
d) transferring of the movement path of the second tool to the kinematic controller, with the result that said kinematic controller, under the secondary condition that the fixing position of the members is maintained, actuates the remaining members of the kinematic chain using the newly parameterized tool center point in such a way that the tool center point follows the movement path of the second tool.

8. The method for controlling a multi-axis robot as claimed in claim 7, wherein the following steps are carried out beforehand:
a) programming of the movement path of the first tool with the aid of a tool center point;
b) programming of the movement path of the second tool with the aid of a tool center point under the secondary condition that the fixing position of the members is maintained.

9. A method for painting an object with a movable component comprising the following steps:
a) providing of a painting robot, with a kinematic chain which has a tool member and at least one further member, the tool member carrying an application unit as a first tool, and the at least one further member carrying a second tool;
b) using of the method as claimed in claim 7 to control the painting robot, in order to move the movable component with the second tool;
c) painting of the object before and/or after the movement of the movable component with the aid of the application unit.

10. A method for implementing a multi-axis robot comprising the following steps:
a) providing a multi-axis robot having a kinematic chain which has a tool member and at least one further member, it being possible for the tool member to carry a first tool, in particular an application unit, and for the at least one further member to carry a second tool;
b) programming of the movement path of the first tool, in particular of the application unit, into a kinematic controller which is set up to accept the movement path of the first tool using a parameterizable tool center point and thereupon to actuate the members of the kinematic chain in such a way that the tool center point follows the movement path;
b) fixing of all the members along the kinematic chain from the tool member to the at least one further member which carries the second tool in a fixing position;
c) parameterizing of the tool center point of the kinematic controller to a working point of the second tool;
d) programming of the movement path of the second tool into the kinematic controller, with the result that said kinematic controller, under the secondary condition that the fixing position of the members is maintained, can actuate the remaining members of the kinematic chain using the newly parameterized tool center point in such a way that the tool center point follows the movement path of the second tool.
